(19) United States
(12) Patent Application Publication
(10) Pub. No.: US 2008/0242063 A1
(43) Pub. Date: Oct. 2, 2008

(54) Solder composition doped with a barrier component and method of making same

(76) Inventors: Mengzhi Pang, Phoenix, AZ (US); Charan Gurumurthy, Higley, AZ (US)

Correspondence Address: INTEL CORPORATION;c/o INTELLEVATE, LLC, P.O. BOX 52050, MINNEAPOLIS, MN, 55402, US

(21) Appl. No.: 11/731,414

(22) Filed: Mar. 30, 2007

(51) Int. Cl. H01R 43/02; B23K 35/24; C22C 1/00

(52) U.S. Cl. 438/499; 148/23; 148/95

(57) ABSTRACT

A solder composition and a method of making the composition. The solder composition comprises a Sn-containing base material and a barrier component having a reactivity with Sn which is higher than a reactivity of Ni or Cu with Sn, the barrier component being present in the composition in an amount sufficient to reduce a reactivity of Sn with both Ni and Cu.

### FIELD

Embodiments of the present invention relate generally to solder compositions of the type used in microelectronic applications.

### BACKGROUND

Electromigration of metals in interconnect structures is a tenacious problem in the microelectronic packaging industry. Electromigration generally refers to the movement of atoms of a metal or other conductor in the direction of electron flow during operation. Such migration or movement of the metal may cause cracks, voids, solder joint separations, or other defects to form within the interconnect structure. The formation of such defects due to electromigration represents a significant problem and may lead to premature failure of the microelectronic package. Potentially compounding this problem is the principle that electromigration generally increases with increasing current density, and the general past and present trend toward ever-smaller interconnect structures having ever-higher current densities.

In fact, electromigration resistance (IMAX) has been one of the key reliability concerns for state of the art packaging technology, especially for high density interconnect/first level interconnect (HDI/FLI) packages. The prior art has attempted to optimize the current capability of C4 solder joints in number of ways, such as, for example, by altering C4 bump size and metallurgy, and substrate surface finishing. Major ongoing challenges however remain regarding IMAX, one such challenge concerning supplier transparency, where IMAX performance may vary as a function of the processing vendor of a given substrate, and another such challenge concerning, as mentioned above, shrinking C4 solder bump sizes which may lead to early IMAX failure.

The prior art fails to provide a reliable C4 solder bumping technology that addresses the IMAX issues noted above.

### BRIEF DESCRIPTION OF THE DRAWINGS

FIG. 1 is a schematic cross-sectional view of a microelectronic package according to an embodiment;

FIG. 2 is a flow chart of a method for forming a solder alloy according to an embodiment; and

FIG. 3 is a schematic view of an embodiment of a system incorporating a microelectronic package as shown in FIG. 1.

For simplicity and clarity of illustration, elements in the drawings have not necessarily been drawn to scale. For example, the dimensions' of some of the elements may be exaggerated relative to other elements for clarity. Where considered appropriate, reference numerals have been repeated among the drawings to indicate corresponding or analogous elements.

### DETAILED DESCRIPTION

In the following detailed description, a microelectronic package, a solder alloy used to form the package, a method to make the solder alloy, and a system including the package are disclosed. Reference is made to the accompanying drawings within which are shown, by way of illustration, specific embodiments by which the present invention may be practiced. It is to be understood that other embodiments may exist and that other structural changes may be made without departing from the scope and spirit of the present invention.

The terms on, above, below, and adjacent as used herein refer to the position of one element relative to other elements. As such, a first element disposed on, above, or below a second element may be directly in contact with the second element or it may include one or more intervening elements. In addition, a first element disposed next to or adjacent a second element may be directly in contact with the second element or it may include one or more intervening elements. In addition, in the instant description, figures and/or elements may be referred to in the alternative. In such a case, for example where the description refers to Figs. X/Y showing an element A/B, what is meant is that Fig. X shows element A and Fig. Y shows element B. In addition, a “layer” as used herein may refer to a layer made of a single material, a layer made of a mixture of different components, a layer made of various sub-layers, each sub-layer also having the same definition of layer as set forth above.

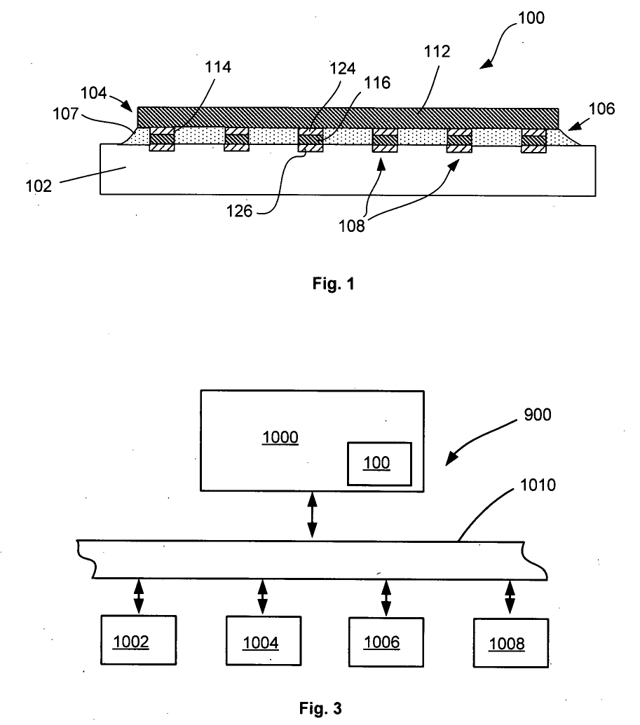

Aspects of this and other embodiments will be discussed herein with respect to FIGS. 1-3 below. The figures, however, should not be taken to be limiting, as it is intended for the purpose of explanation and understanding.

Referring first to FIG. 1, a microelectronic package 100 is shown according to one embodiment. Package 100 includes a substrate 102, and a die 104 bonded to the substrate by a bond 106. As seen in FIG. 1, a plurality of joint structures 108 are shown between the die 104 and the substrate 102, the joint structures 108 forming at least part of bond 106. Optionally, the bond 106 may also include an underfill material 107 provided in a well known manner. Referring still to FIG. 1, the joint structures 108 include die under-bump metallization (“die UBM”) 124 on the die 104, and substrate surface finish 126 on the substrate. As is well known the die UBM 124 and surface finish 126 allow an electrical bonding of the die and substrate, respectively, to external circuitry. It is noted that, although the die UBM 124 and substrate surface finish 126 are shown as a single layer, it is understood that, in the context of the instant description, they not only include the under bump metallization layers of the die/substrate proper to enable external electrical contact, but also the metallization (such as, for example, Cu bumps on the die, ENIG, ENIG-EG, NiPdAu surface finish on the substrate, etc.) provided as part of the die UBM and/or substrate surface finish in a well known manner. By “UBM,” what is meant in the context of the instant application is a site including one or more metallization layers on a bonding pad of a microelectronic component (such as, for example, a die or a substrate), the bumping site adapted to allow an electrical and mechanical joining of the microelectronic component with another microelectronic component, such as through a solder connection. An example of a bumping site as used herein would thus, as noted above, comprise the well known ENIG or ENIG-EG pad, including a barrier layer comprising for example a layer of Ni capped by a layer of Au. As further shown in FIG. 1, joint structures 108 further comprise solidified solder joints 116 bonding the die 104 and the substrate 102 to one another. According to embodiments, as shown in an exemplary fashion in FIG. 1, the solder joints 116 comprise Sn, and, in addition, a barrier component substantially uniformly distributed throughout each of the solder joints 116, and present in an amount sufficient to reduce a reactivity of Sn with both Ni and Cu. Preferably, the barrier component comprises Pd. By “barrier component,” what is meant in the context of the instant description is a component that is adapted to reduce a reactivity of Sn with Ni and Cu, and an interdiffusivity of Sn, Ni and Cu. By “a barrier component substantially uniformly distributed,” what is meant in the context of embodiments is a barrier component in any form, such as, for example, an alloy of the barrier component, an inter-metallic compound (IMC) including the barrier component, or the barrier component in pure form, which does not exhibit local elevated concentrations at any given region of the solder joints. Where the barrier component comprises Pd, the solder joints 116 may include, for example, PdSn4, Pd IMC's such as (PdxNi1-x)Sn4, (CuNiPd)1-xSnx or (CuPd)1-xSnx with the possibility of Au inclusion in either of those IMC's.

According to embodiments, a solder composition adapted to yield a solder joint such as the solder joints 116 of FIG. 1 may comprise a Sn-containing base material and a barrier component having a reactivity with Sn which is higher than a reactivity of Ni or Cot with Sn, the barrier component being present in the composition at an amount sufficient to reduce a reactivity of Sn with both Ni and Cu. The growth of IMC's including a combination of Sn with Ni or Cu may be slowed by barrier component doping, such as doping with Pd, by a factor of about four. By “barrier component,” what is meant in the context of embodiments is any component, such as for example, an element having an intrinsic reactivity with Sn which is faster than that of Ni or Cu with Sn. For example, where Pd is the barrier component according to one embodiment, Pd has an intrinsic reactivity with Sn with is roughly up to about ten times faster than a reactivity of either Ni or Cu with Sn. According to an embodiment, the solder composition may comprise a Sn-containing base material that is Pd-doped, preferably containing up to about 3% by weight of Pd therein. Most preferably, the solder composition according to an embodiment contains between about 0.01% and about 1% by weight Pd therein. The base material may include, by way of example, SnAg, SnPb, SnAgCu, SnIn, SnInCu, SnInAg, and the like. The effective amount of barrier component, such as Pd, to be added to the base material may be empirically determined as a function of the specific barrier component and base material used, as would be within the knowledge of one skilled in the art.

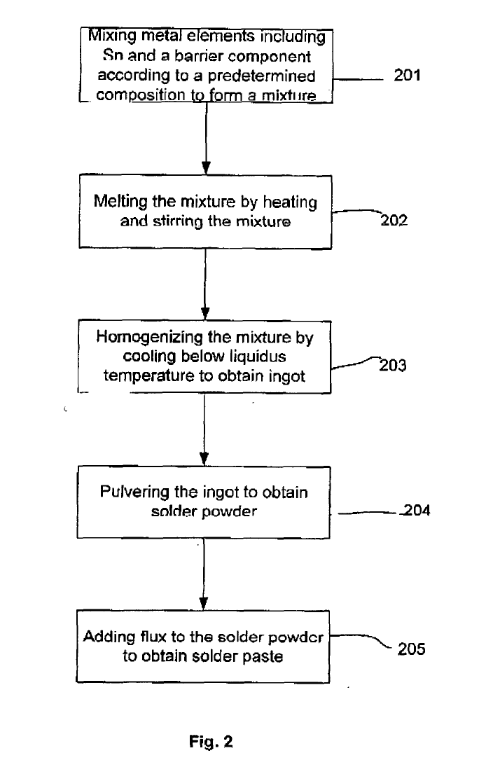

Referring to FIG. 2, a flowchart is shown of a process for making a solder paste according to an embodiment. As seen in FIG. 2, a method embodiment includes providing a solder ingot with barrier component doping, such as Pd doping by up to about 3% by weight of the Pd. Doping may be achieved through conventional solder alloying procedures, such as, for example, by mixing pure respective metal elements according to a designated composition, and then heating up the mixture to melt the same, stirring constantly to ensure uniformity of the alloy distribution. After cool down, a homogenization process may be effected in a temperature below the liquidus of the solder alloy. Fabrication of a solder alloy as noted above result in a barrier component doped ingot, such as a Pd-doped ingot, having substantially uniform distribution throughout of the barrier component, such as Pd. To make solder paste from said ingot, solder powder may be formed from the same using conventional methods, and then flux added therein to make solder paste. Doped solder paste thus fabricated may then be used in a conventional C4 bumping and bonding process as would be recognized by one skilled in the art. Although a method embodiment for forming solder paste is described above, embodiments include within their scope the provision of a doped solder composition in any form, such as, for example, in the form of micro solder-balls.

Embodiments present a solder alloy to fundamentally improve C4 solder joint IMAX performance by doping C4 solder material with trace amounts of a barrier component, such as Pd metal. The presence of a barrier component such as Pd in a Sn-based solder may impede a relatively fast diffusion into Sn/reaction with Sn of Cu from the die Cu bumps, and thus delay an intrinsic IMAX failure based on Sn consumption. In particular, the presence of a barrier component such as Pd in Sn-based solder may impede the growth rate of Ni3Sn4 and Cu5Sn6 IMC's during IMAX testing. The intrinsic reactivity of Pd with Sn is much faster than that of Ni or Cu with Sn. Thus, during solder reflow, and during solid state reaction, Pd may react with Sn in a preferred manner, and thus significantly lower the diffusion and reaction of Sn with Ni and Cu, in this way resulting in a prolonged IMAX life for Sn-based solder joints. In addition, a barrier component such as Pd may alter the morphology of interfacial IMC's, and further help to reduce the diffusivity and reactivity of Sn with Ni and Cu. Pd containing IMC's, such as, for example, (PdxNi1-x)Sn4, are typically bulkier than Ni3Sn4 IMC's, which are more needle like. Thus, there exist fewer phase boundaries for an interface (i.e. an interface existing between solder and bonding pad) including Pd containing IMC's than for an interface where the IMC's do not include Pd. As a result, solder doped with a barrier component such as Pd decreases the diffusion of bonding pad components, such as Cu and Ni, out of the Cu bumps of the die and Ni pads of the substrate, in this way reducing IMC growth and benefiting electromigration resistance.

Referring to FIG. 3, there is illustrated one of many possible systems 900 in which embodiments of the present invention may be used. In one embodiment, the electronic assembly 1000 may include a microelectronic package, such as package 100 of FIG. 1. Assembly 1000 may further include a microprocessor. In an alternate embodiment, the electronic assembly 1000 may include an application specific IC (ASIC). Integrated circuits found in chipsets (e.g., graphics, sound, and control chipsets) may also be packaged in accordance with embodiments of this invention.

For the embodiment depicted by FIG. 3, the system 900 may also include a main memory 1002, a graphics processor 1004, a mass storage device 1006, and/or an input/output module 1008 coupled to each other by way of a bus 1010, as shown. Examples of the memory 1002 include but are not limited to static random access memory (SRAM) and dynamic random access memory (DRAM). Examples of the mass storage device 1006 include but are not limited to a hard disk drive, a compact disk drive (CD), a digital versatile disk drive (DVD), and so forth. Examples of the input/output module 1008 include but are not limited to a keyboard, cursor control arrangements, a display, a network interface, and so forth. Examples of the bus 1010 include but are not limited to a peripheral control interface (PCI) bus, and Industry Standard Architecture (ISA) bus, and so forth. In various embodiments, the system 90 may be a wireless mobile phone, a personal digital assistant, a pocket PC, a tablet PC, a notebook PC, a desktop computer, a set-top box, a media-center PC, a DVD player, and a server.

The various embodiments described above have been presented by way of example and not by way of limitation. Having thus described in detail embodiments of the present invention, it is understood that the invention defined by the appended claims is not to be limited by particular details set forth in the above description, as many variations thereof are possible without departing from the spirit or scope thereof.

1. A solder composition comprising a Sn-containing base material and a barrier component having a reactivity with Sn which is higher than a reactivity of Ni or Cu with Sn, the barrier component being present in the composition in an amount sufficient to reduce a reactivity of Sn with both Ni and Cu.

2. The solder composition of claim 1, wherein the barrier component comprises Pd.

3. The solder composition of claim 2, wherein the Pd is present in the composition at up to about 3% by weight.

4. The solder composition of claim 3, wherein the Pd is present in the composition between about 0.01% and about 1% by weight.

5. The solder composition of claim 1, wherein the Sn-containing base material comprises one of SnAg, SnPb, SnAgCu, SnIn, SnInCu and SnInAg.

6. A method of making a solder composition comprising:
providing a Sn-containing base material;
doping the Sn-containing base material with a barrier component having a reactivity with Sn which is higher than a reactivity of Ni or Cu with Sn the barrier equipment being present in the composition in an amount sufficient to reduce a reactivity of Sn with both Ni and Cu.

7. The method of claim 6, wherein the Sn-containing base material comprises one of SnAg, SnPb, SnAgCu, SnIn, SnInCu and SnInAg.

8. The method of claim 6, wherein the barrier component comprises Pd.

9. The method of claim 8, wherein doping comprises doping the Sn-containing base material with Pd to achieve a solder composition having up to about 3% by weight Pd.

10. The method of claim 1, wherein providing and doping comprise:
mixing respective metal elements according to a predetermined composition to form a mixture, the metal elements comprising Sn and the barrier component;
melting the mixture by heating;
stirring the mixture to ensure substantial uniformity thereof; and
cooling the mixture after melting and stirring to obtain a cooled mixture.

11. The method of claim 10, further comprising homogenizing the cooled mixture at a temperature below a liquidus of the cooled mixture to obtain a doped solder ingot having a substantially uniform barrier component distribution therethrough.

12. The method of claim 11, further comprising:
pulverizing the ingot to obtain solder powder; and
adding flux to the solder powder to obtain solder paste.

13. A microelectronic package comprising:
a package substrate;
a die-electrically and mechanically bonded to the package-substrate; and
a plurality of solder joints mechanically and electrically bonding the die to the package substrates each of the solder joints comprising Sn and a barrier component, the barrier component being substantially uniformly distributed throughout each of the solder joints, and further being present in an amount sufficient to reduce a reactivity of Sn with both Ni and Cu.

14. The package of claim 13, wherein the barrier component comprises Pd.

15. The package of claim 14, wherein the Pd is present in each of the solder joints at up to about 3% by weight.
